(19) United States
(12) Patent Application Publication
(10) Pub. No.: US 2021/0373733 A1
(43) Pub. Date: Dec. 2, 2021

(54) DISPLAY DEVICE WITH A BUILT-IN TOUCH PANEL

(71) Applicant: Sharp Kabushiki Kaisha, Sakai City (JP)

(72) Inventors: Daiji KITAGAWA, Sakai City (JP); Jin MIYAZAWA, Sakai City (JP); Yousuke NAKAMURA, Sakai City (JP); Daisuke SUEHIRO, Sakai City (JP)

(21) Appl. No.: 17/318,117

(22) Filed: May 12, 2021

Related U.S. Application Data
(60) Provisional application No. 63/031,598, filed on May 29, 2020.

(51) Int. Cl. G06F 3/041; G06F 3/044

(52) U.S. Cl. CPC G06F 3/04164; G06F 3/044; G06F 3/0412

(57) ABSTRACT

A display device includes a liquid crystal layer provided between a first substrate and a second substrate, a plurality of touch sensors provided between the first substrate and the second substrate, a touch detection unit configured to perform control of detecting a touch on the basis of capacitance values of the plurality of touch sensors, a pair of wiring lines connected to at least one of the plurality of touch sensors, and a resistance value acquisition unit connected to the pair of wiring lines and configured to acquire, via the pair of wiring lines, a resistance value of a touch sensor to which the pair of wiring lines are connected.

### CROSS-REFERENCE TO RELATED APPLICATIONS

This application claims the benefit of priority to U.S. Provisional Application No. 63/031,598 filed on May 29, 2020. The entire contents of the above-identified application are hereby incorporated by reference.

### BACKGROUND

### Technical Field

The disclosure relates to a display device with a built-in touch panel.

There have been known display devices with a built-in touch panel that include a touch panel and are configured to detect a touch by a finger or the like. Such a display device with a built-in touch panel is disclosed in, for example, JP 2017-504139 T.

JP 2017-504139 T described above discloses a display device including an in-cell touch panel. This in-cell touch panel includes an upper substrate, a lower substrate disposed facing the upper substrate, and a plurality of self-capacitance electrodes disposed between the upper substrate and the lower substrate.

### SUMMARY

Here, as a method of inspecting a touch panel, it is conceivable to acquire a resistance value of the self-capacitance electrode, for example. Then, it is conceivable that a quality of the touch panel is judged by an inspection worker on the basis of the acquired resistance value. Nevertheless, in a display device including an in-cell touch panel (display device with a built-in touch panel) such as described in JP 2017-504139 T, the self-capacitance electrodes are disposed between the upper substrate and the lower substrate. Therefore, when an attempt is made to judge the quality of the in-cell touch panel after manufacture of the display device with a built-in touch panel, the display device with a built-in touch panel needs to be disassembled in order to acquire (measure) the resistance value of the self-capacitance electrode. In this case, it is difficult to disassemble the display device with a built-in touch panel once the touch panel is built into the display device. Even if disassembly is possible, because the self-capacitance electrode is a relatively small, precision component, measuring the resistance value of the self-capacitance electrode is considered not easy. Accordingly, a display device with a built-in touch panel that allows easy inspection of a touch sensor on the basis of the resistance value of the touch sensor, even for a display device with a built-in touch panel in which a self-capacitance electrode (touch sensor) is disposed between the upper substrate and the lower substrate (first substrate and second substrate), is desired.

In order to solve problems such as described above, an object of this disclosure is to provide a display device with a built-in touch panel that, even for a display device with a built-in touch panel in which a touch sensor is disposed between a first substrate and a second substrate, allows easy inspection of the touch sensor on the basis of a resistance value of the touch sensor.

To achieve the object described above, a display device with a built-in touch panel according to a first aspect disclosed below includes a first substrate, a second substrate facing the first substrate, a liquid crystal layer provided between the first substrate and the second substrate, a plurality of touch sensors provided between the first substrate and the second substrate, a touch detection unit configured to acquire a capacitance value of the plurality of touch sensors and detect a touch on the basis of the capacitance value being acquired, a pair of wiring lines connected to at least one of the plurality of touch sensors, and a resistance value acquisition unit connected to the pair of wiring lines and configured to acquire, via the pair of wiring lines, a resistance value of a touch sensor of the plurality of touch sensors to which the pair of wiring lines are connected.

According to this configuration, the resistance value of the touch sensor can be acquired by the resistance value acquisition unit via the pair of wiring lines without disassembling the first substrate and the second substrate from each other. That is, the resistance value of the touch sensor can be acquired by the resistance value acquisition unit in a non-destructive manner. Further, because the pair of wiring lines are provided in the display device with a built-in touch panel in advance, precision work is not required when the resistance value is acquired. As a result, even for a display device with a built-in touch panel (display device including an in-cell type touch panel) in which a touch sensor is disposed between a first substrate and a second substrate, the touch sensor can be easily inspected on the basis of the acquired resistance value of the touch sensor.

### BRIEF DESCRIPTION OF DRAWINGS

The disclosure will be described with reference to the accompanying drawings, wherein like numbers reference like elements.

FIG. 1 is a cross-sectional view illustrating a schematic configuration of a display device with a built-in touch panel according to a first embodiment.

FIG. 2 is a schematic plan view illustrating an example of gate wiring lines and source wiring lines formed on a first substrate.

FIG. 3 is an equivalent circuit diagram of a pixel.

FIG. 4 is a schematic plan view illustrating a configuration of touch sensors and resistance value acquisition wiring lines.

FIG. 5 is a diagram for explaining measurement of a resistance value (resistance value measurement mode) of a first specific touch sensor by an in-cell driver IC.

FIG. 6 is a diagram for explaining measurement of a resistance value (resistance value measurement mode) of a second specific touch sensor by the in-cell driver IC.

FIG. 7 is a diagram for explaining a normal operating mode of the in-cell driver IC.

FIG. 8 is a block diagram illustrating a configuration related to output of inspection information.

FIG. 9 is a cross-sectional view illustrating a schematic configuration of a display device with a built-in touch panel according to a second embodiment.

FIG. 10 is a diagram for explaining detection of a short circuit.

FIG. 11 is a diagram illustrating a configuration of a display device with a built-in touch panel according to a third embodiment.

FIG. 12 is a diagram illustrating a configuration of a display device with a built-in touch panel according to a fourth embodiment.

### DESCRIPTION OF EMBODIMENTS

Embodiments of the disclosure will be described below with reference to the drawings. Note that the disclosure is not limited to the following embodiments, and appropriate design changes can be made within a scope that satisfies the configuration of the disclosure. Further, in the description below, the same reference signs are used in common among the different drawings for portions having the same or similar functions, and descriptions of repetitions thereof will be omitted. Further, the configurations described in the embodiments and the modified examples may be combined or modified as appropriate within a range that does not depart from the gist of the disclosure. Further, for ease of explanation, in the drawings referenced below, the configuration is simplified or schematically illustrated, or a portion of the components are omitted. Further, the dimensional ratios between the components illustrated in the drawings are not necessarily indicative of actual dimensional ratios.

### First Embodiment

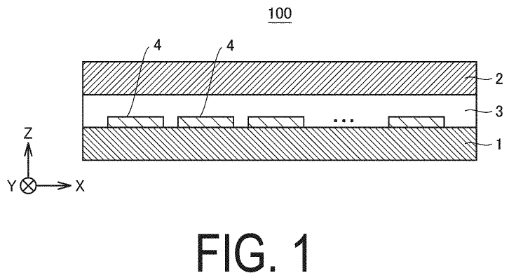

FIG. 1 is a cross-sectional view schematically illustrating a basic configuration of a display device 100 with a built-in touch panel (hereinafter referred to as “display device 100”) according to a first embodiment. The display device 100 includes a first substrate 1, a second substrate 2, and a liquid crystal layer 3. The first substrate 1 is configured as an active matrix substrate, for example. The second substrate 2 is configured as a counter substrate disposed facing the active matrix substrate. The liquid crystal layer 3 is disposed between the first substrate 1 and the second substrate 2. Specifically, the liquid crystal layer 3 is interposed between the first substrate 1 and the second substrate 2.

Then, the display device 100 has a function of displaying an image and has a function of detecting information (touch position) of a position input by a user on the basis of the displayed image. A touch sensor 4 of this display device 100 is formed between the first substrate 1 and the second substrate 2. That is, the touch sensor 4 is provided inside a display panel. That is, the display device 100 includes an in-cell touch panel (in-cell type touch panel).

The first substrate 1 and the second substrate 2 each include a glass substrate that is substantially transparent (has high light-transmittance). For example, the display device 100 includes a backlight (not illustrated) provided in a planar direction of the first substrate 1 on a side opposite to the liquid crystal layer 3, and a pair of polarizers (not illustrated) sandwiching the first substrate 1 and the second substrate 2. For example, the second substrate 2 includes a color filter (not illustrated) of the three colors: red (R), green (G), and blue (B).

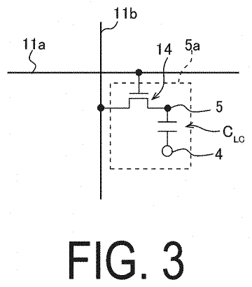

Further, a driving method of liquid crystal molecules included in the liquid crystal layer 3 is a transverse electrical field driving method. In order to achieve a transverse electrical field driving method, a pixel electrode 5 (refer to FIG. 3) for forming an electrical field is formed on the first substrate 1. Further, the touch sensor 4 is disposed facing the pixel electrode 5. That is, the touch sensor 4 is configured as a counter electrode (common electrode).

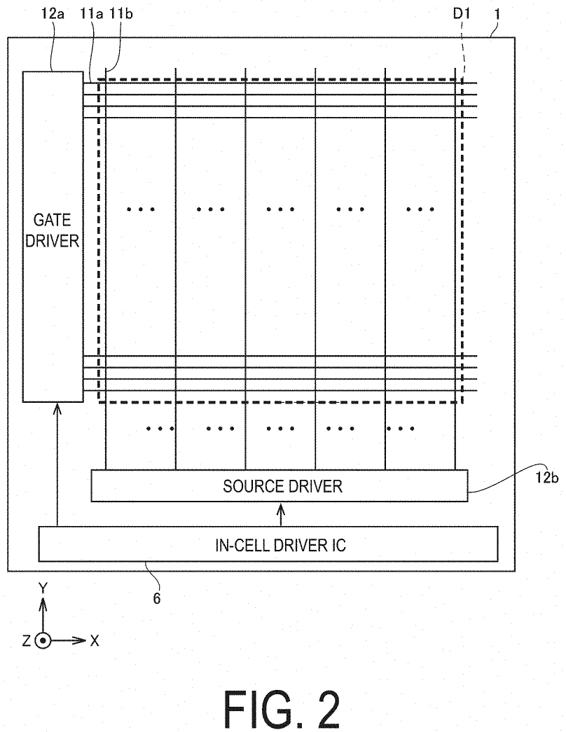

FIG. 2 is a plan view illustrating a schematic configuration of the first substrate 1. The first substrate 1 includes a plurality of gate lines 11a, a plurality of source lines 11b, a gate driver 12a, a source driver 12b, and an in-cell driver integrated circuit (IC) 6. Although not illustrated in FIG. 2, the first substrate 1 is provided with the pixel electrode 5 (refer to FIG. 3) in a region defined by the gate line 11a and the source line 11b, forming a pixel 5a. The first substrate 1 includes a display region D1 composed of a plurality of the pixels 5a. Each pixel electrode 5 is provided correspondingly to any one of the colors R, G and B of the color filter (not illustrated) provided on the second substrate 2.

Then, the gate driver 12a and the source driver 12b are provided in a frame region further outside than the display region D1. Further, the in-cell driver IC 6 is, for example, provided in the frame region and connected to the gate driver 12a and the source driver 12b. The in-cell driver IC 6 is a processor that executes a control process by executing a program, for example.

The in-cell driver IC 6 supplies, to the gate driver 12a, a control signal such as a synchronization signal (vertical synchronization signal, horizontal synchronization signal) indicating timing for writing an image to each pixel, and a clock signal for driving the source driver 12b and the gate driver 12a, in accordance with a frame rate.

The gate driver 12a includes a shift register (not illustrated) provided correspondingly to each gate line 11a. The shift register is connected to one corresponding gate line 11a. Each shift register of the gate driver 12a applies, to each gate line 11a, a scanning voltage that switches between selection and non-selection of the gate line 11a on the basis of the synchronization signal and the control signal supplied from the in-cell driver IC 6.

The source driver 12b is connected to each source line 11b. The source driver 12b supplies a data signal for displaying an image to each source line 11b on the basis of the control signal supplied from the in-cell driver IC 6.

FIG. 3 is a diagram illustrating an equivalent circuit of one pixel 5a. The pixel 5a includes the touch sensor 4, the pixel electrode 5, and a thin film transistor (TFT) 14. In the TFT 14, a gate electrode is connected to the gate line 11a, a source electrode is connected to the source line 11b, and a drain electrode is connected to the pixel electrode 5. A capacitance C_{LC} is formed between the pixel electrode 5 and the touch sensor 4. Further, the touch sensor 4 has parasitic capacitance. That is, the display device 100 includes a self-capacitance touch sensor (touch panel).

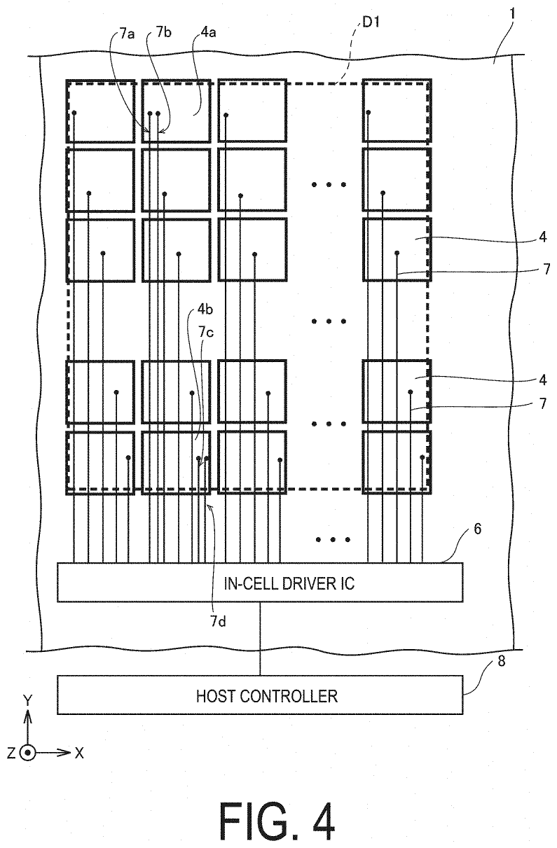

FIG. 4 is a schematic view illustrating an example of a disposition of the touch sensor 4 formed on the first substrate 1. For example, the touch sensor 4 has a rectangular shape when viewed in the Z direction (in plan view). Further, a plurality of the touch sensors 4 are provided. Then, the plurality of touch sensors 4 are disposed side by side in a matrix shape on the first substrate 1. The touch sensor 4 is provided in an upper layer than the pixel electrode 5 (refer to FIG. 3) on a surface of the first substrate 1 on the liquid crystal layer 3 (refer to FIG. 1) side. The touch sensor 4 has, for example, a substantially square shape with one side being several millimeters, and is larger than a pixel. Note that, although not illustrated in FIG. 4, a slit (having a width of several μm, for example) for generating a transverse electrical field between the touch sensor 4 and the pixel electrode 5 is formed in the touch sensor 4. Note that, although 20 touch sensors 4 are illustrated in FIG. 4 for the sake of explanation, no such limitation is intended by this example, and any number of touch sensors 4 can be disposed on the first substrate 1. Further, the shape of the touch sensor 4 is not limited to a rectangular shape, and may be a diamond shape or the like.

Further, the display device 100 is provided with a plurality of touch sensor wiring lines 7 and a host controller 8.

The plurality of touch sensor wiring lines 7 are each connected to the plurality of touch sensors 4. Then, the touch sensor wiring line 7 connects one touch sensor 4 to the in-cell driver IC 6 described later. For example, each of the plurality of touch sensor wiring lines 7 is formed extending in the Y direction in the first substrate 1. Then, the touch sensor wiring line 7 is configured to transmit a touch detection signal S1 from the touch sensor 4 to the in-cell driver IC 6.

Here, in the first embodiment, among the plurality of touch sensors 4 disposed side by side in a matrix shape, one touch sensor 4 of the plurality of touch sensors 4 provided at one end in the Y direction (the touch sensor 4 farthest from the in-cell driver IC 6) is a first specific touch sensor 4a to be inspected, and one touch sensor 4 of the plurality of touch sensors 4 provided at the other end in the Y direction (an end portion opposite to the Y direction; the touch sensor 4 closest to the in-cell driver IC 6) is a second specific touch sensor 4b to be inspected. According to this configuration, the first specific touch sensor 4a and the second specific touch sensor 4b, which are representative touch sensors, can be inspected and thus, compared to a case in which the display device 100 is configured to perform inspection of all touch sensors 4, an increase in complexity in the configuration of the display device 100 can be suppressed. Further, the first specific touch sensor 4a and the second specific touch sensor 4b are separated from each other, making it possible to inspect the touch sensors 4 efficiently in a macroscopic manner.

Then, in the first embodiment, the display device 100 is provided with a pair of resistance value acquisition wiring lines 7a, 7b and a pair of resistance value acquisition wiring lines 7c, 7d. The pair of resistance value acquisition wiring lines 7a, 7b are provided in the first specific touch sensor 4a. The pair of resistance value acquisition wiring lines 7c, 7d are provided in the second specific touch sensor 4b. Then, the pair of resistance value acquisition wiring lines 7a, 7b connect the first specific touch sensor 4a and the in-cell driver IC 6. Further, the pair of resistance value acquisition wiring lines 7c, 7d connect the second specific touch sensor 4b and the in-cell driver IC 6.

For example, the resistance value acquisition wiring lines 7a to 7d are each formed extending in the Y direction in the first substrate 1. That is, in the first embodiment, the resistance value acquisition wiring lines 7a to 7d are formed along the touch sensor wiring line 7. According to this configuration, the resistance value acquisition wiring lines 7a to 7d and the touch sensor wiring line 7 formed along each other can be formed in the same layer. As a result, an increase in size of the display device 100 in the planar direction can be suppressed.

Here, in the first embodiment, the resistance value acquisition wiring lines 7a, 7c of the resistance value acquisition wiring lines 7a to 7d also serve as the touch sensor wiring line 7. That is, the resistance value acquisition wiring line 7a is configured to transmit the touch detection signal S1 from the first specific touch sensor 4a to the in-cell driver IC 6. Further, the resistance value acquisition wiring line 7c is configured to transmit the touch detection signal S1 from the second specific touch sensor 4b to the in-cell driver IC 6. According to this configuration, it is not necessary to provide the touch sensor wiring line 7 separately from the resistance value acquisition wiring lines 7a to 7d, and thus an increase in complexity in the configuration between the first substrate 1 and the second substrate 2 (inside the panel) can be suppressed.

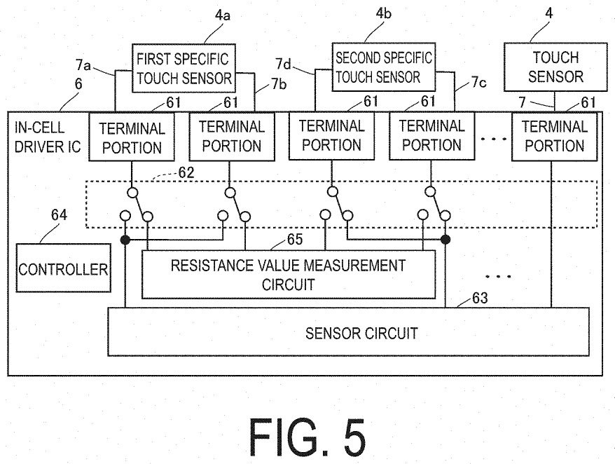

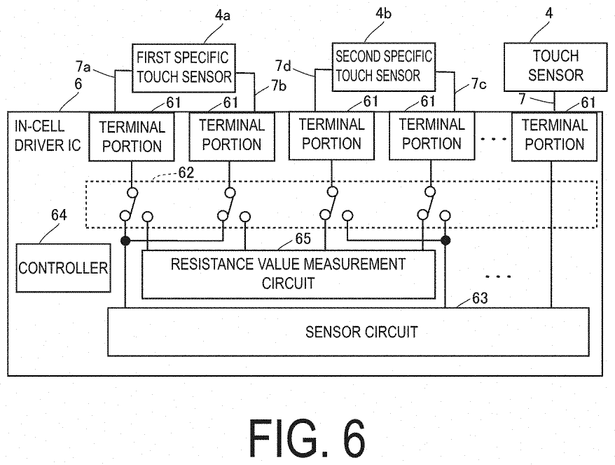

Then, when a resistance value R1 of the first specific touch sensor 4a is measured (in a resistance value measurement mode), the pair of resistance value acquisition wiring lines 7a, 7b are connected to a resistance value measurement circuit 65 (refer to FIG. 5). Further, when a resistance value R2 of the second specific touch sensor 4b is measured (in the resistance value measurement mode), the pair of resistance value acquisition wiring lines 7c, 7d are connected to the resistance value measurement circuit 65 (refer to FIG. 6).

Further, the in-cell driver IC 6 is configured to execute control in one of a normal operating mode in which image display and touch position detection are performed, and the resistance value measurement mode in which the resistance value R1 of the first specific touch sensor 4a and the resistance value R2 of the second specific touch sensor 4b are acquired.

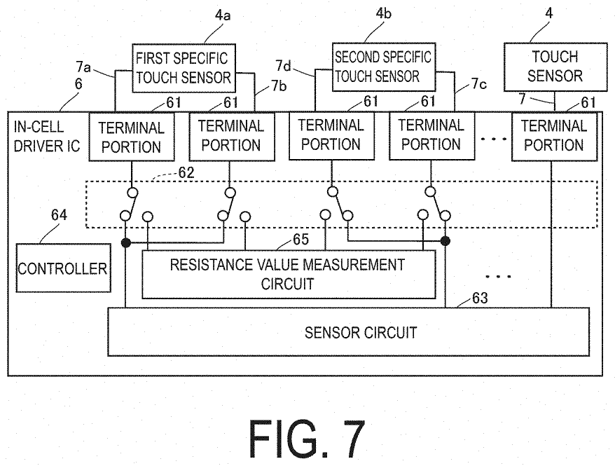

FIG. 5, FIG. 6, and FIG. 7 are block diagrams schematically illustrating a configuration of the in-cell driver IC 6. The in-cell driver IC 6 includes a plurality of terminal portions 61, a switch unit 62, a sensor circuit 63, a controller 64, and the resistance value measurement circuit 65. The plurality of terminal portions 61 are each connected to the plurality of touch sensor wiring lines 7 and the resistance value acquisition wiring lines 7a to 7d.

The switch unit 62 is configured to switch between a state of the resistance value acquisition wiring lines 7a, 7b and the resistance value measurement circuit 65 being connected (refer to FIG. 5), a state of the resistance value acquisition wiring lines 7c, 7d, and the resistance value measurement circuit 65 being connected (refer to FIG. 6), and a state of the plurality of touch sensor wiring lines 7 and the sensor circuit 63 being connected and each of the resistance value acquisition wiring lines 7a, 7c and the sensor circuit 63 being connected (refer to FIG. 7), in accordance with a command from the controller 64. According to this configuration, even when at least one of the resistance value acquisition wiring lines 7a, 7b serves as the touch sensor wiring line 7, the connection state between the wiring lines and the sensor circuit 63, and between the wiring lines and the resistance value measurement circuit 65 can be readily switched by the switch unit 62. Further, as illustrated in FIG. 7, on a conductor (wiring line) connecting the switch unit 62 and the sensor circuit 63, the resistance value acquisition wiring line 7a and the resistance value acquisition wiring line 7b may be connected, and the resistance value acquisition wiring line 7c and the resistance value acquisition wiring line 7d may be connected. Here, in a case in which the resistance value acquisition wiring line 7a and the resistance value acquisition wiring line 7b are not connected and the resistance value acquisition wiring line 7c and the resistance value acquisition wiring line 7d are not connected, conceivably, in a state in which each of the resistance value acquisition wiring lines 7a, 7c and the sensor circuit 63 are connected, the resistance value acquisition wiring line 7b increases a capacitance load of the first specific touch sensor 4a, and the resistance value acquisition wiring line 7d increases a capacitance load of the second specific touch sensor 4b. Here, according to the configuration of FIG. 7, in a state in which each of the resistance value acquisition wiring lines 7a, 7c and the sensor circuit 63 are connected, the resistance value acquisition wiring lines 7b, 7d are also connected to the sensor circuit 63, and thus an increase in the capacitance load caused by the resistance value acquisition wiring lines 7b, 7d can be suppressed.

The sensor circuit 63 acquires a capacitance value C of each of the touch sensors 4 via the plurality of touch sensor wiring lines 7 and the resistance value acquisition wiring lines 7a, 7c. The sensor circuit 63 transmits the acquired capacitance values C to the controller 64. For example, the sensor circuit 63 scans the capacitance values C of all touch sensors 4 at 120 Hz in the normal operating mode. The controller 64 acquires a change in the capacitance values C acquired from the sensor circuit 63 as the touch detection signal S1, and generates information on a touch position of a finger or the like on the basis of the touch detection signal S1.

The controller 64 is configured to switch between the normal operating mode and the resistance value measurement mode in response to a command from the host controller 8. For example, the controller 64 switches from the normal operating mode to the resistance value measurement mode in response to acquiring a resistance value measurement signal S2 from the host controller 8, and switches (returns) from the resistance value measurement mode to the normal operating mode on the basis of completion of the control (measurement of the resistance values R1, R2) in the resistance value measurement mode. According to this configuration, when acquisition of the resistance values R1, R2 is desired, as long as the controller 64 is made to acquire the resistance value measurement signal S2, the resistance values R1, R2 can be acquired (measured) when desired.

Specifically, the controller 64 switches the switch unit 62 in response to acquiring the resistance value measurement signal S2 from the host controller 8, thereby switching from a state in which each of the plurality of touch sensor wiring lines 7 and the sensor circuit 63 are connected and each of the resistance value acquisition wiring lines 7a, 7c and the sensor circuit 63 are connected in FIG. 7 to a state in which the resistance value acquisition wiring lines 7a, 7b and the resistance value measurement circuit 65 are connected in FIG. 5. Further, after measuring the resistance value R1, the controller 64 switches from the state in which the resistance value acquisition wiring lines 7a, 7b and the resistance value measurement circuit 65 are connected in FIG. 5 to a state in which the resistance value acquisition wiring lines 7c, 7d and the resistance value measurement circuit 65 are connected in FIG. 6. Subsequently, the controller 64 returns it to the state in FIG. 7.

FIG. 7 is a diagram schematically illustrating the switch unit 62 when the in-cell driver IC 6 performs control in the normal operating mode. The in-cell driver IC 6, in the normal operating mode, intermittently switches between image display control for displaying an image and touch position detection control for detecting a touch position. For example, during image display control, the in-cell driver IC 6 performs two scans (at 120 Hz) to acquire the capacitance value C for touch position detection while scanning the display at 60 Hz. During the period in which image display control is performed, the in-cell driver IC 6 applies a constant voltage for image display (hereinafter, common voltage) to the touch sensor 4 to make the touch sensor 4 function as a common electrode. During the period in which image display control is performed, each gate line 11a is scanned by the gate driver 12a under the control of the in-cell driver IC 6, and the data signal of the image to be displayed in the pixel 5a of the scanned gate line 11a is supplied from the source driver 12b. Thus, the capacitance C_{LC} between the pixel electrode 5 of the pixel 5a of the scanned gate line 11a and the touch sensor 4 changes, and an image corresponding to the data signal is displayed on the pixel 5a.

Further, during the period in which touch position detection control is performed, the in-cell driver IC 6 applies a voltage signal (voltage) for touch position detection per fixed period of time. The in-cell driver IC 6, during the period in which touch position detection control is performed, acquires, via the touch sensor wiring line 7, a voltage signal in response to an electrical field in each touch sensor 4, and acquires a change in the capacitance value C (touch detection signal S1) on the basis of the acquired voltage signal.

FIG. 5 and FIG. 6 schematically illustrate the state of the switch unit 62 in the resistance value measurement mode. Here, in the first embodiment, the in-cell driver IC 6 (resistance value measurement circuit 65) is configured to sequentially acquire each of the resistance values R1, R2 in a time-division manner. According to this configuration, the resistance values R1, R2 can be sequentially acquired by one in-cell driver IC 6 (resistance value measurement circuit 65) and thus, even in a case in which a plurality of touch sensors 4 are provided, an increase in complexity in the configuration of the display device 100 can be suppressed compared to a case in which the number of resistance value measurement circuits 65 provided is the same as the number of the plurality of touch sensors 4.

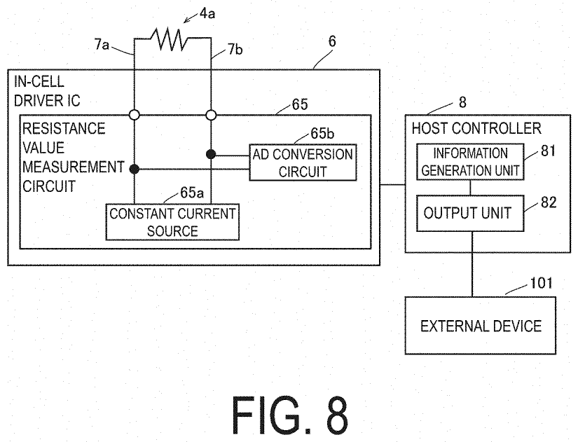

FIG. 8 illustrates a block diagram related to a configuration of the resistance value measurement circuit 65. The resistance value measurement circuit 65 includes a constant current source 65a and an analog-digital (AD) conversion circuit 65b. The constant current source 65a is configured to apply a current having a constant current value to the first specific touch sensor 4a via the pair of resistance value acquisition wiring lines 7a, 7b. That is, the constant current source 65a, the resistance value acquisition wiring line 7a, the first specific touch sensor 4a, and the resistance value acquisition wiring line 7b form a loop (circuit), in this order. Then, the AD conversion circuit 65b is connected to the pair of resistance value acquisition wiring lines 7a, 7b, and is configured to convert a potential difference (analog value) of both ends of the first specific touch sensor 4a into a digital value.

Then, the controller 64 (refer to FIG. 5 and FIG. 6) is configured to acquire a digital value from the resistance value measurement circuit 65 and acquire the resistance value R1 on the basis of the digital value (according to Ohm's Law). Note that the controller 64 may acquire the resistance value R1 by referring to a table in which the potential difference and the resistance value R1 are associated, and may acquire the resistance value R1 by performing a predetermined operation on the information of the potential difference. Note that in a case in which the resistance values of the resistance value acquisition wiring lines 7a, 7b are known in advance, the controller 64 may be configured to perform a process that differentiates the resistance values of the resistance value acquisition wiring lines 7a, 7b from the measurement results. Then, the controller 64 is configured to transmit the acquired resistance value R1 to the host controller 8. Although FIG. 8 illustrates a configuration related to the acquisition of the resistance value R1, the same configuration as that of FIG. 8 is used for the acquisition of the resistance value R2, and thus description thereof will be omitted.

The host controller 8 is disposed, for example, at a position away from the first substrate 1 in the display device 100. Then, the host controller 8 is configured to transmit the resistance value measurement signal S2 to the in-cell driver IC 6 in response to a command signal (command) input from an external device 101. Note that the external device 101 is, for example, a device connected to the display device 100 wirelessly or wiredly in the inspection step after manufacture of the display device 100 or during maintenance work of the display device 100.

Further, the host controller 8 includes an information generation unit 81 and an output unit 82. The information generation unit 81 is configured to transmit, via the output unit 82, inspection information including the information of the resistance values R1, R2 to the external device 101 (detection device, for example). The output unit 82 is configured as, for example, an Inter-Integrated Circuit (I2C) interface. Then, the host controller 8 transmits the inspection information to the external device via the output unit 82. Then, the external device 101 receives the inspection information. Subsequently, for example, the resistance values R1, R2 included in the inspection information are displayed by the external device 101, and the user or the inspection worker checks (determines) whether the resistance values R1, R2 are within the design range. That is, according to this configuration, the inspection information can be easily checked by a user or an inspection worker using the external device 101 into which the inspection information is input.

Then, according to the configuration described above, the resistance value R1 of the first specific touch sensor 4a and the resistance value R2 of the second specific touch sensor 4b can be acquired by the in-cell driver IC 6 and the host controller 8 via the pair of resistance value acquisition wiring lines 7a, 7b without disassembling the first substrate 1 and the second substrate 2 from each other. That is, the host controller 8 can acquire the resistance value R1 of the first specific touch sensor 4a and the resistance value R2 of the second specific touch sensor 4b in a non-destructive manner. Further, by provision of the pair of resistance value acquisition wiring lines 7a, 7b in the display device 100, precision work is unnecessary when the resistance values R1, R2 are acquired. As a result, even for the display device 100 (display device including an in-cell type touch panel) in which the plurality of touch sensors 4 are disposed between the first substrate 1 and the second substrate 2, the first specific touch sensor 4a and the second specific touch sensor 4b can be easily inspected on the basis of the resistance value R1 of the first specific touch sensor 4a and the resistance value R2 of the second specific touch sensor 4b acquired.

### Second Embodiment

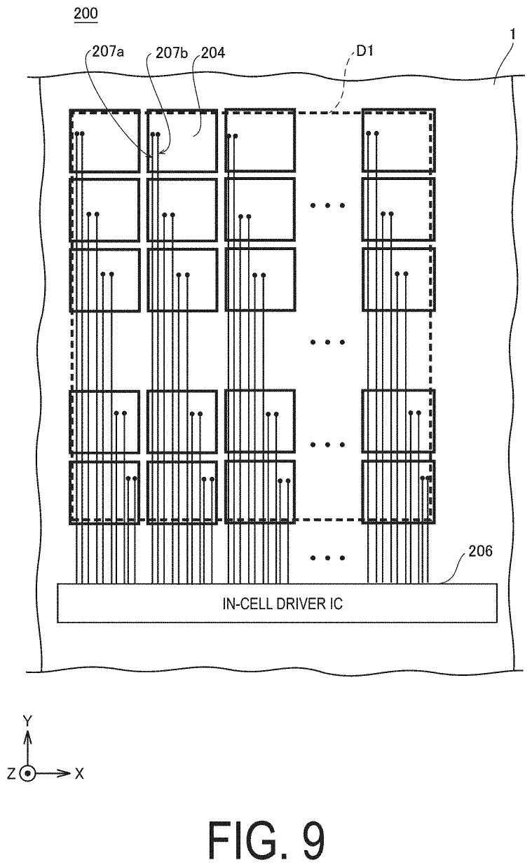

FIG. 9 illustrates a configuration of a display device 200 with a built-in touch panel (hereinafter referred to as “display device 200”) according to a second embodiment. In the second embodiment, unlike the display device 100 of the first embodiment in which the resistance value acquisition wiring lines 7a to 7d are provided only to the first specific touch sensor 4a and the second specific touch sensor 4b of the plurality of touch sensors 4, a pair of resistance value acquisition wiring lines 207a, 207b are provided to each of all touch sensors 204. Note that the same configurations as those of the first embodiment will be denoted by the same reference signs as those of the first embodiment, and descriptions thereof will be omitted.

The display device 200 includes a plurality of the touch sensors 204, an in-cell driver IC 206, and the pair of resistance value acquisition wiring lines 207a, 207b provided correspondingly to each of all touch sensors 204. The plurality of touch sensors 204, similar to the touch sensors 4 of the first embodiment, are disposed in a matrix shape on the first substrate 1. Then, the pairs of (two) resistance value acquisition wiring lines 207a, 207b extending in the Y direction are connected to each of all touch sensors 204. According to this configuration, all touch sensors 204 of the plurality of touch sensors 204 can be inspected, and thus the quality of the display device 200 can be more accurately judged than a case in which this configuration is not adopted.

The in-cell driver IC 206 is configured to acquire, in the resistance value measurement mode, a resistance value R3 of each touch sensor 204 in a time-division manner. Further, the resistance value acquisition wiring line 207a of the pair of resistance value acquisition wiring lines 207a, 207b also serves as the touch sensor wiring line.

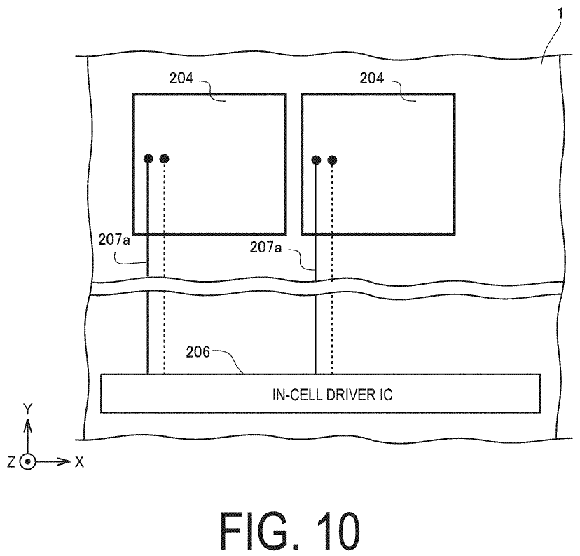

FIG. 10 illustrates a schematic view related to detection of a short circuit between the plurality of touch sensors 204. In the resistance value measurement mode, the in-cell driver IC 206 performs control to detect a short circuit between the plurality of touch sensors 204 by acquiring resistance values R4 via the plurality of resistance value acquisition wiring lines 207a. According to this configuration, even in the in-cell type display device 200, a short circuit between the plurality of touch sensors 204 can be readily detected. Further, by acquisition of the resistance values R4 via the plurality of resistance value acquisition wiring lines 207a, a short circuit between the touch sensors 204 can be detected while suppressing an increase in complexity in the configuration of the display device 200 compared to a case in which a new wiring line for short circuit detection is provided.

For example, the in-cell driver IC 206 constitutes a circuit of touch sensors 204 adjacent to each other and two resistance value acquisition wiring lines 207a connected to the touch sensors 204 adjacent to each other by a switch unit (not illustrated). Then, the in-cell driver IC 206 acquires the resistance value R4 between the touch sensors 204 adjacent to each other. Then, the in-cell driver IC 206 determines that there is no short circuit when the resistance value R4 is greater than or equal to a predetermined value (substantially infinite value), and determines that there is a short circuit when the resistance value R4 is smaller than the predetermined value. Then, the in-cell driver IC 206 performs control of sequentially detecting a short circuit between the touch sensors 204 adjacent to each other for all touch sensors 204. Then, the in-cell driver IC 206 is configured to output a short circuit detection result to the host controller (not illustrated). Note that the other configurations of the second embodiment are the same as the configurations of the first embodiment.

### Third Embodiment

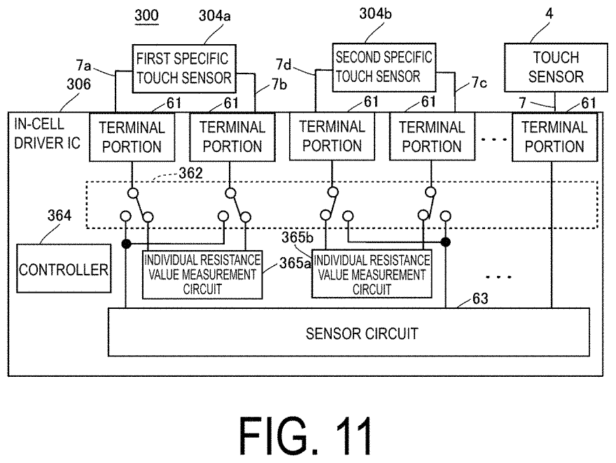

FIG. 11 illustrates a configuration of a display device 300 with a built-in touch panel (hereinafter referred to as “display device 300”) according to a third embodiment. In the first embodiment, unlike the display device 100 of the first embodiment that measures the resistance values R1, R2 of both the first specific touch sensor 4a and the second specific touch sensor 4b by one resistance value measurement circuit 65, a first specific touch sensor 304a and a second specific touch sensor 304b are provided with individual resistance value measurement circuits 365a, 365b, respectively. Note that the same components as those of the first or second embodiment will be denoted by the same reference signs as those of the first or second embodiment, and descriptions thereof will be omitted.

The display device 300 includes an in-cell driver IC 306, a switch unit 362, and the individual resistance value measurement circuits 365a, 365b. In the resistance value measurement mode, the in-cell driver IC 306 connects the pair of resistance value acquisition wiring lines 7a, 7b and the individual resistance value measurement circuit 365a, and connects the pair of resistance value acquisition wiring lines 7c, 7d and the individual resistance value measurement circuit 365b. Then, the individual resistance value measurement circuit 365a measures the resistance value R1. Further the individual resistance value measurement circuit 365b measures the resistance value R2. According to this configuration, the individual resistance value measurement circuits 365a, 365b can simultaneously measure the resistance value R1 of the first specific touch sensor 304a and the resistance value R2 of the second specific touch sensor 304b, making it possible to suppress an increase in measurement time. Note that the other configurations of the third embodiment are the same as those in the first embodiment.

### Fourth Embodiment

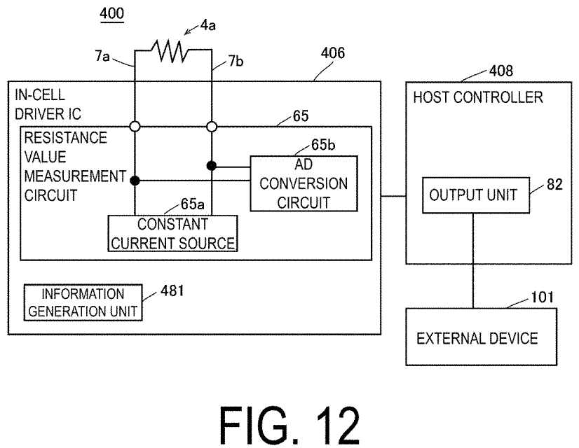

FIG. 12 illustrates a configuration of a display device 400 with a built-in touch panel (hereinafter referred to as “display device 400”) according to a fourth embodiment. In the fourth embodiment, an in-cell driver IC 406 is configured to generate inspection result information on the basis of the acquired resistance value R1. Note that the same components as those of any one of the first to third embodiments will be denoted by the same reference signs as those of any one of the first to third embodiments, and descriptions thereof will be omitted.

The display device 400 includes the in-cell driver IC 406 and a host controller 408. The in-cell driver IC 406 includes an information generation unit 481. The information generation unit 481 is configured to generate inspection result information on the basis of the resistance values R1, R2 acquired by the resistance value measurement circuit 65 and the capacitance value C acquired by the sensor circuit (not illustrated). For example, the information generation unit 481 performs control to determine whether or not each of the resistance values R1, R2 is within a predetermined range (design range). Further, the information generation unit 481 performs control to determine whether or not the capacitance value C of each touch sensor is within a predetermined range (design range). Then, the information generation unit 481 generates inspection result information including a determination result indicating whether or not each of the resistance values R1, R2 is within a predetermined range (design range) and a determination result indicating whether or not the capacitance value C of each touch sensor is within a predetermined range (design range).

The host controller 408 is configured to acquire the inspection result information from the in-cell driver IC 406 and output the acquired inspection result information via the output unit 82 to the external device 101. Note that the other configurations of the fourth embodiment are the same as those in the first embodiment.

Although examples of the display device with a built-in touch panel have been described above, the display device with a built-in touch panel is not limited to the configurations of the first to fourth embodiments described above, and may have various modified configurations. Below, modified examples of the display device will be described.

(1) The display device with a built-in touch panel in the first to fourth embodiments described above may be used in a mobile information terminal such as a smartphone or a tablet terminal, or a personal computer or the like. The mobile information terminal or the personal computer causes the display device with a built-in touch panel to execute each process such as image display and touch position detection, but may include a sleep function that temporarily suspends a portion of processing, including image display, when a user operation is not performed for a certain period of time or the like. After the sleep function is activated, measurement of the resistance value of the touch sensor may be started by transmitting a resistance value acquisition signal to the in-cell driver IC.

(2) In the first to fourth embodiments described above, an example has been illustrated in which the touch sensor is configured as a counter electrode facing the pixel electrode, but no such limitation is intended. For example, the touch sensor and the counter electrode may be configured as separate members.

(3) In the first to fourth embodiments described above, an example has been illustrated in which one resistance value acquisition wiring line of the pair of resistance value acquisition wiring lines also serves as a touch sensor wiring line, but no such limitation is intended. That is, both resistance value acquisition wiring lines of the pair of resistance value acquisition wiring lines may be formed separately from the touch sensor wiring line without serving as a touch sensor wiring line.

(4) In the first to fourth embodiments described above, an example has been illustrated in which the sensor circuit, the resistance value measurement circuit, and the switch unit are provided in the in-cell driver IC, but no such limitation is intended. That is, any one of the sensor circuit, the resistance value measurement circuit, and the switch unit may be provided separately from the in-cell driver IC.

(5) In the first to fourth embodiments described above, an example has been illustrated in which the in-cell driver IC and the host controller are provided separately, but no such limitation is intended. That is, the in-cell driver IC and the host controller may be constituted by one element.

(6) In the first to fourth embodiments described above, an example has been illustrated in which the in-cell driver IC is configured to perform control to switch the switch unit (operation mode) on the basis of the acquisition of the resistance value measurement signal, but no such limitation is intended. That is, the in-cell driver IC may be configured to periodically switch the switch unit regardless of whether or not the resistance value measurement signal is acquired.

(7) In the first to fourth embodiments described above, an example has been illustrated in which the number of touch sensors for which the resistance value is measured is two or all (more than or equal to two) of the plurality of touch sensors, but no such limitation is intended. For example, the display device may be configured to acquire a resistance value of only one touch sensor of the plurality of touch sensors.

(8) In the second embodiment described above, an example has been illustrated in which a short circuit between touch sensors adjacent to each other is detected, but no such limitation is intended. That is, a short circuit between touch sensors spaced apart and not adjacent to each other may be detected. In this case, a short circuit between touch sensors may be detected in the configuration of the first embodiment as well.

(9) In the first to fourth embodiments described above, an example has been illustrated in which the output unit is configured as an I2C interface, but no such limitation is intended. That is, the output unit may be configured as a serial interface other than the I2C interface, or may be configured as a parallel interface.

(10) In the first to third embodiments described above, the inspection information may further include information on the capacitance value of the touch sensor. In this case, the touch sensor can be inspected on the basis of the capacitance value as well as the resistance value.

(11) In the first to fourth embodiments described above, an example has been illustrated in which the resistance value acquisition wiring line is formed along the touch sensor wiring line, but no such limitation is intended. For example, the resistance value acquisition wiring line may be formed intersecting the touch sensor wiring line.

(12) In the second embodiment described above, an example has been illustrated in which the resistance values of all touch sensors are measured sequentially by one resistance value measurement circuit, but no such limitation is intended. For example, when two resistance value measurement circuits are provided in the in-cell driver IC and the resistance values of a portion of the touch sensors are measured by one of the resistance value measurement circuits and the resistance values of the other portion of touch sensors are measured by the other resistance value measurement circuit, the resistance values of all touch sensors can be measured in half the time compared to that of the configuration of the second embodiment.

The display device with a built-in touch panel described above can also be described as follows.

A display device with a built-in touch panel according to a first configuration includes a first substrate, a second substrate facing the first substrate, a liquid crystal layer provided between the first substrate and the second substrate, a plurality of touch sensors provided between the first substrate and the second substrate, a touch detection unit configured to acquire a capacitance value of the plurality of touch sensors and detect a touch on the basis of the capacitance value being acquired, a pair of wiring lines connected to at least one of the plurality of touch sensors, and a resistance value acquisition unit connected to the pair of wiring lines and configured to acquire, via the pair of wiring lines, a resistance value of a touch sensor of the plurality of touch sensors to which the pair of wiring lines are connected (first configuration).

According to the first configuration, the resistance value of the touch sensor can be acquired by the resistance value acquisition unit via the pair of wiring lines without disassembling the first substrate and the second substrate from each other. That is, the resistance value of the touch sensor can be acquired by the resistance value acquisition unit in a non-destructive manner. Further, because the pair of wiring lines are provided in the display device with a built-in touch panel in advance, precision work is not required when the resistance value is acquired. As a result, even for a display device with a built-in touch panel (display device including an in-cell type touch panel) in which a touch sensor is disposed between a first substrate and a second substrate, the touch sensor can be easily inspected on the basis of the acquired resistance value of the touch sensor.

In the first configuration described above, one wiring line of the pair of wiring lines may be a touch sensor wiring line configured to transmit a touch detection signal from the touch sensor to which the pair of wiring lines are connected to the touch detection unit (second configuration).

According to the second configuration, it is not necessary to provide the touch sensor wiring line separately from the pair of wiring lines, and thus an increase in complexity in the configuration between the first substrate and the second substrate (inside the panel) can be suppressed.

In the second configuration, the touch detection unit may include a sensor circuit configured to acquire the touch detection signal via the touch sensor wiring line and the resistance value acquisition unit may include a resistance value measurement circuit configured to acquire a resistance value of the touch sensor to which the pair of wiring lines are connected, via the pair of wiring lines and a switch unit configured to switch between a state of the sensor circuit and the touch sensor wiring line being connected, and a state of the resistance value measurement circuit and the pair of wiring lines being connected (third configuration).

According to the third configuration, even when at least one wiring line of the pair of wiring lines also serves as the touch sensor wiring line, the connection state between the wiring lines and the sensor circuit, and between the wiring lines and the resistance value measurement circuit can be readily switched by the switch unit.

In the third configuration described above, the resistance value acquisition unit may be configured to switch the switch unit and thus switch from a state of the sensor circuit and the touch sensor wiring line being connected to a state of the resistance value measurement circuit and the pair of wiring lines being connected, on the basis of acquiring a resistance value measurement signal (fourth configuration).

According to the fourth configuration, when acquisition of the resistance value of the touch panel is desired, as long as the resistance value acquisition unit is made to acquire the resistance value measurement signal, the resistance value of the touch panel can be acquired (measured) when desired.

In the first configuration described above, the display device with a built-in touch panel may further include a first of the pair of wiring lines connected to a first touch sensor of the plurality of touch sensors provided at one end, and a second of the pair of wiring lines connected to a second touch sensor of the plurality of touch sensors provided at the other end, the plurality of touch sensors being disposed side by side (fifth configuration).

According to the fifth configuration, representative touch sensors (the first touch sensor and the second touch sensor) can be inspected and thus, compared to a case in which a display device with built-in touch panel is configured to inspect all touch sensors, an increase in complexity in the configuration of the display device with built-in touch panel can be suppressed. Further, the first touch sensor and the second touch sensor are separated from each other, making it possible to inspect the touch sensors efficiently in a macroscopic manner.

In the first configuration described above, the display device with a built-in touch panel may further include a short circuit detection unit configured to detect a short circuit between the plurality of touch sensors by acquiring resistance values via a plurality of the pair of wiring lines connected to the plurality of touch sensors (sixth configuration).

According to the sixth configuration, even in an in-cell type display device, a short circuit between the plurality of touch sensors can be readily detected. Further, by acquiring resistance values via the plurality of wiring lines, a short circuit between the touch sensors can be detected while suppressing an increase in complexity in the configuration of the display device with built-in touch panel compared to a case in which a new wiring line for short circuit detection is provided.

In the first configuration described above, the resistance value acquisition unit may include a time-division resistance value measurement circuit configured to sequentially acquire a resistance value of each of the plurality of touch sensors via the pair of wiring lines in a time-division manner (seventh configuration).

According to the seventh configuration, the resistance value of each of the plurality of touch sensors can be sequentially acquired by one time-division resistance value measurement circuit and thus, even in a case in which a plurality of the touch sensors are provided, an increase in complexity in the configuration of the display device with built-in touch panel can be suppressed compared to a case in which the number of resistance value measurement circuits provided is the same as the number of the plurality of touch sensors.

In the first configuration described above, the resistance value acquisition unit may include a plurality of individual resistance value measurement circuits each provided to the plurality of touch sensors to which the pair of wiring lines are connected (eighth configuration).

According to the eighth configuration, the resistance values of the plurality of touch sensors can be simultaneously measured by the plurality of individual resistance value measurement circuits, and thus an increase in measurement time can be suppressed even in a case in which the resistance values of the plurality of touch sensors are measured.

In the first configuration described above, the pair of wiring lines may be provided correspondingly to all of the plurality of touch sensors (ninth configuration).

According to the ninth configuration, all touch sensors of the plurality of touch sensors can be inspected, and thus the quality of the display device with a built-in touch panel can be more accurately judged than a case in which the ninth configuration is not adopted.

In the first configuration described above, the resistance value acquisition unit may include an output unit configured to output, to an external device, inspection information including a resistance value of the touch sensor to which the pair of wiring lines are connected (tenth configuration).

According to the tenth configuration, the inspection information can be easily checked by a user or an inspection worker using the external device into which the inspection information is input.

In the first configuration described above, the display device with a built-in touch panel may further include a plurality of touch sensor wiring lines each connected to the plurality of touch sensors, and at least one wiring line of the pair of wiring lines may be formed along at least one of the plurality of touch sensor wiring lines (eleventh configuration).

Here, in a case in which the pair of wiring lines and the plurality of touch sensor wiring lines are formed intersecting each other, it is conceivable that the pair of wiring lines and the plurality of touch sensor wiring lines need to be formed in mutually different layers. Thus, according to the eleventh configuration, at least one wiring line of the pair of wiring lines is formed along at least one of the plurality of touch sensor wiring lines, making it possible to form the wiring lines formed along each other in the same layer. As a result, an increase in size of the display device with a built-in touch panel in a planar direction can be suppressed.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A display device with a built-in touch panel comprising:
a first substrate;
a second substrate facing the first substrate;
a liquid crystal layer provided between the first substrate and the second substrate;
a plurality of touch sensors provided between the first substrate and the second substrate;
a touch detection unit configured to acquire a capacitance value of the plurality of touch sensors and detect a touch on the basis of the capacitance value being acquired;
a pair of wiring lines connected to at least one of the plurality of touch sensors; and
a resistance value acquisition unit connected to the pair of wiring lines and configured to acquire, via the pair of wiring lines, a resistance value of a touch sensor of the plurality of touch sensors to which the pair of wiring lines are connected.

2. The display device with a built-in touch panel according to claim 1,
wherein one wiring line of the pair of wiring lines is a touch sensor wiring line configured to transmit a touch detection signal from the touch sensor to which the pair of wiring lines are connected to the touch detection unit.

3. The display device with a built-in touch panel according to claim 2,
wherein the touch detection unit includes a sensor circuit configured to acquire the touch detection signal via the touch sensor wiring line and
the resistance value acquisition unit includes
a resistance value measurement circuit configured to acquire a resistance value of the touch sensor to which the pair of wiring lines are connected via the pair of wiring lines and
a switch unit configured to switch between a state of the sensor circuit and the touch sensor wiring line being connected and a state of the resistance value measurement circuit and the pair of wiring lines being connected.

4. The display device with a built-in touch panel according to claim 3,
wherein the resistance value acquisition unit is configured to switch the switch unit and thus switch from a state of the sensor circuit and the touch sensor wiring line being connected to a state of the resistance value measurement circuit and the pair of wiring lines being connected on the basis of acquiring a resistance value measurement signal.

5. The display device with a built-in touch panel according to claim 1, further comprising:
a first of the pair of wiring lines connected to a first touch sensor of the plurality of touch sensors provided at one end; and
a second of the pair of wiring lines connected to a second touch sensor of the plurality of touch sensors provided at the other end,
wherein the plurality of touch sensors are disposed side by side.

6. The display device with a built-in touch panel according to claim 1, further comprising:
a short circuit detection unit configured to detect a short circuit between the plurality of touch sensors by acquiring a resistance value via a plurality of the pair of wiring lines connected to the plurality of touch sensors.

7. The display device with a built-in touch panel according to claim 1,
wherein the resistance value acquisition unit includes a time-division resistance value measurement circuit configured to sequentially acquire a resistance value of each of the plurality of touch sensors via the pair of wiring lines in a time-division manner.

8. The display device with a built-in touch panel according to claim 1,
wherein the resistance value acquisition unit includes a plurality of individual resistance value measurement circuits each provided to the plurality of touch sensors to which the pair of wiring lines are connected.

9. The display device with a built-in touch panel according to claim 1,
wherein the pair of wiring lines are provided correspondingly to all of the plurality of touch sensors.

10. The display device with a built-in touch panel according to claim 1,
wherein the resistance value acquisition unit includes an output unit configured to output, to an external device, inspection information including a resistance value of the touch sensor to which the pair of wiring lines are connected.

11. The display device with a built-in touch panel according to claim 1, further comprising:
a plurality of touch sensor wiring lines each connected to the plurality of touch sensors,
wherein at least one wiring line of the pair of wiring lines is formed along at least one of the plurality of touch sensor wiring lines.
